(19) United States
(12) Patent Application Publication
(10) Pub. No.: US 2007/0272751 A1
(43) Pub. Date: Nov. 29, 2007

(54) Storage device having self-diagnosis function, control device that controls self-diagnosis function in storage device, and method of performing self-diagnosis on storage device

(75) Inventor: Hiroshi Tsurumi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/522,774

(22) Filed: Sep. 18, 2006

(30) Foreign Application Priority Data
May 24, 2006 (JP) 2006-144669

(51) Int. Cl. G06K 5/00; G06K 7/00

(52) U.S. Cl. 235/437; 235/435

(57) ABSTRACT

A storage device includes a recording medium having a user-area and a system-area. The storage device conducts a self-diagnostic test on a recording medium. When conducting the self-diagnostic test, a writing/reading unit performs writing of data in and reading of data from the system area at a user-area write/read frequency that is a frequency for writing of data in and reading of data from the user area.

### BACKGROUND OF THE INVENTION

1. Field of the Invention

The present invention generally relates to a storage device having a user-area and a system-area, and specifically relates to a storage device that conducts a self-diagnostic test to detect whether there is an error.

2. Description of the Related Art

It is a common practice to perform a self-diagnostic test on a magnetic disk device to check whether head failure or circuit failure has occurred in the magnetic disk device. Such a test is generally performed periodically. The magnetic disk device includes one or more recording media for magnetically storing data. In the self-diagnostic test, data is read from the recording medium and it is checked whether there is error in the read data. A recording medium generally has a user area for storing user data and a system area for storing system data. There is a risk of loss of data during the self-diagnostic test. The user data is important data so that it is not desirable to lose it. To avoid loss of the user data, Japanese Patent Application Laid-Open No. H6-314472 discloses to perform the self-diagnostic test only with respect to the system-area.

The frequencies at which data is read from or written in the system-area (hereinafter, “system-area write/read frequency”) and user-area (hereinafter, “user-area write/read frequency”) are different. Therefore, even if there is no write/read failure in the system-area, that does not mean that there is no write/read failure in the user area. With the technology disclosed in Japanese Patent Application Laid-Open No. H6-314472, because the self-diagnostic test is performed only with respect to the system-area, it is not possible to check whether there is error data in the user area.

### SUMMARY OF THE INVENTION

It is an object of the present invention to at least partially solve the problems in the conventional technology.

According to an aspect of the present invention, a storage device including a recording medium having a user-area and a system-area, and that implements a self-diagnostic test includes a writing/reading unit that, in the self-diagnostic test, performs writing of data in and reading of data from the system area at a user-area write/read frequency that is a frequency for writing of data in and reading of data from the user area.

According to an aspect of the present invention, a control device that causes a storage device to perform a self-diagnostic test on a recording medium having a user-area and a system-area includes a writing/reading unit that, when causing the storage device to perform the self-diagnostic test, performs writing of data in and reading of data from the system area at a user-area write/read frequency that is a frequency for writing of data in and reading of data from the user area.

According to still another aspect of the present invention, a method of performing a self-diagnostic test on a recording medium having a user-area and a system-area, includes performing, in the self-diagnostic test, writing of data in and reading of data from the system area at a user-area write/read frequency that is a frequency for writing of data in and reading of data from the user area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an overview of a magnetic disk device according to a first embodiment of the present invention;

FIG. 2 is a plan view of a magnetic disk according to the first embodiment;

FIG. 3 is a flowchart of a process procedure performed by the magnetic disk device shown in FIG. 1; and

FIG. 4 is a flowchart of another process procedure performed by the magnetic disk device shown in FIG. 1.

### DETAILED DESCRIPTION OF THE PREFERRED EMBODIMENTS

Exemplary embodiments of the present invention are explained below with reference to the accompanying drawings. A magnetic disk device is presented as the storage device according to a first embodiment of the present invention.

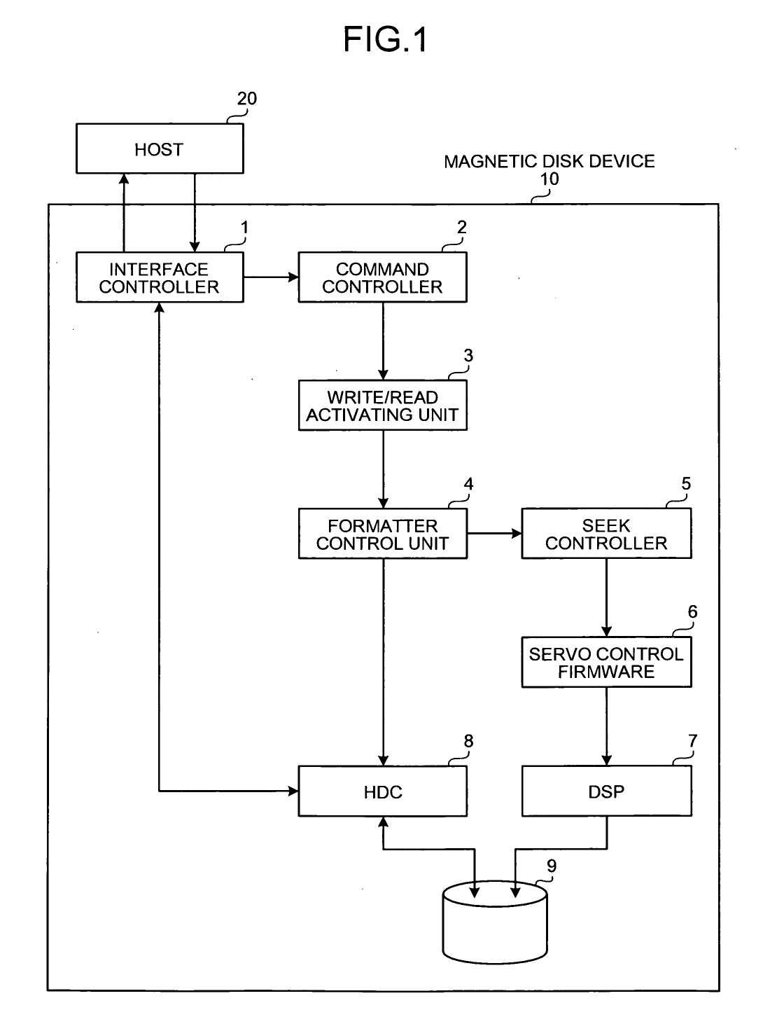

FIG. 1 is a schematic for explaining the overview of a magnetic disk device 10 according to a first embodiment of the present invention. The magnetic disk device 10 includes a recording medium (disk) 9. The recording medium 9 includes a user-area and a system-area. The user-area is an area in which user data is written, and the system-area is an area in which system data is written. A self-diagnostic test is performed to detect a user-area writ/read frequency-dependent head or circuit failure.

Specifically, the magnetic disk device 10 includes an interface controller 1, a command controller 2, a write/read activating unit 3, a formatter control unit 4, a seek controller 5, a servo control firmware 6, a digital signal processor (DSP) 7, a hard disk controller (HDC) 8, and a disk 9.

The magnetic disk device 10 is connected to a host 20, which is a higher-level device. The interface control unit 1 controls data communication between the magnetic disk device 10 and the host 20. The command controller 2 controls the entire magnetic disk device 10. The command controller 2, for example, controls various processes of the magnetic disk device 10 based on commands received from the host 20. The write/read activating unit 3 controls the formatter control unit 4 based on commands received from the command controller 2.

The formatter control unit 4 activates the HDC 8 and controls writing data to and reading data from the disk 9, and in addition, controls the activation of the seek controller 5. For example, when activating the seek control, the formatter control unit 4 sets a self-diagnostic seek control flag ON so that the head can seek the system-area of the disk 9. The seek controller 5 sets a Seek command in the servo control firmware 6, and in addition, activates the DSP 7 and controls the seek operation of the head. For example, if a self-diagnostic seek control flag is set ON by the formatter control unit 4, the seek controller 5 sets a cylinder value of the system-area of the disk 9 required for the self-diagnostic test and a Seek command in the servo control firmware 6.

The servo control firmware 6 controls the head position once the seek control flag and the Seek command are set by the formatter control unit 4. The DSP 7 performs the seek operation of the head. The HDC 8 writes data to and reads data from the disk 9.

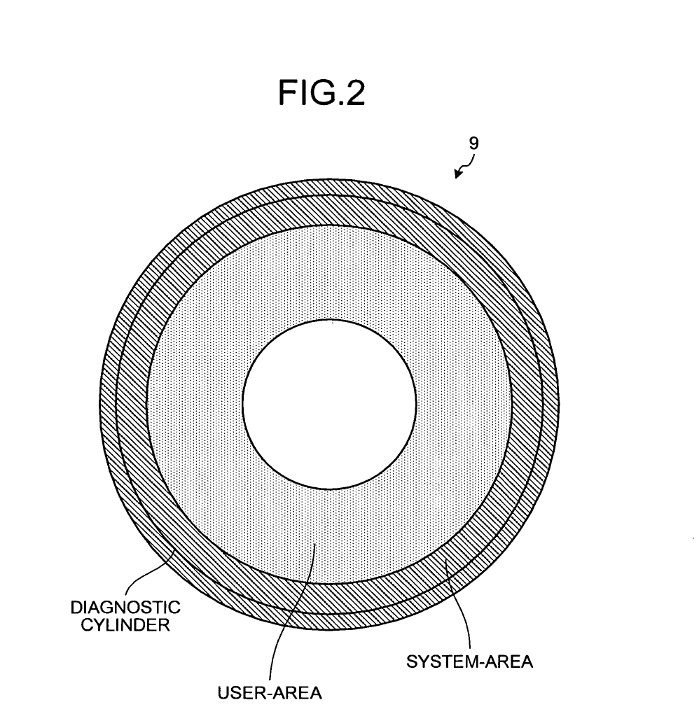

The disk 9 is a recording medium for storing data. FIG. 2 is a plan view of the disk 9. The disk 9 includes a user-area and a system-area. The system-area includes a diagnostic cylinder.

The host 20 can be a server device, etc., that controls the magnetic disk device 10 by issuing commands to the magnetic disk device 10. Upon receiving a command from the host 20 via the interface controller 1, the command controller 2 of the magnetic disk device 10 checks the content of the command. If the command pertains to a self-diagnostic test, the command controller 2 issues a Perform self-diagnostic test command to the write/read activating unit 3.

Upon receiving the Perform self-diagnostic test command, the write/read activating unit 3 issues a Write/Read command to the formatter control unit 4 to write data to and read the written data from user-area of the disk 9. The Write/Read command specifies a format setting corresponding to a predetermined sector of the user-area in the disk 9. Upon receiving the Write/Read command, the formatter control unit 4 creates a self-diagnostic seek control flag indicating that the seek operation is for self-diagnosis, and sets the self-diagnostic seek control flag in the seek controller 5, and activates the seek controller 5.

The activated seek controller 5 checks whether the self-diagnostic seek control flag is set, and if set, ignores the cylinder value specified in the command received by the formatter control unit 4 from the write/read activating unit 3, and sets a self-diagnostic cylinder value and a Seek command in the servo control firmware 6. The self-diagnostic cylinder value is set such that the head is positioned at the diagnostic cylinder in the system-area of the disk 9. The seek controller 5 then activates the DSP 7. The activated DSP 7 receives control directions for the head position from the servo control firmware 6 and performs the seek operation of the head on the diagnostic cylinder. After the seek operation of the head by the DSP 7, the head is positioned at the diagnostic cylinder of the disk 9. At the end of a seek operation, the seek controller 5 resets the self-diagnostic seek control flag.

After completion of the seek operation, the formatter control unit 4 activates the HDC 8 and writes data to the disk 9. Because the Write command received by the formatter control unit 4 from the write/read activating unit 3 includes, the cylinder value of a predetermined sector of the user-area, the format control 4 activates the HDC 8 so that data is written to the disk 9 at a user-area write frequency.

In this manner, data is written in the diagnostic cylinder at a user-area write frequency. Data in the diagnostic cylinder is read in a similar manner. After the data is read from the magnetic disk device 10, the process for writing and reading of data for the self-diagnostic test is terminated. Then, the data written in and the data read from the diagnostic cylinder are compared to check for any data garbling to detect head or circuit failure.

Thus, the magnetic disk device 10 can perform a self-diagnostic test to detect a user-area write/read frequency-dependent head or circuit failure.

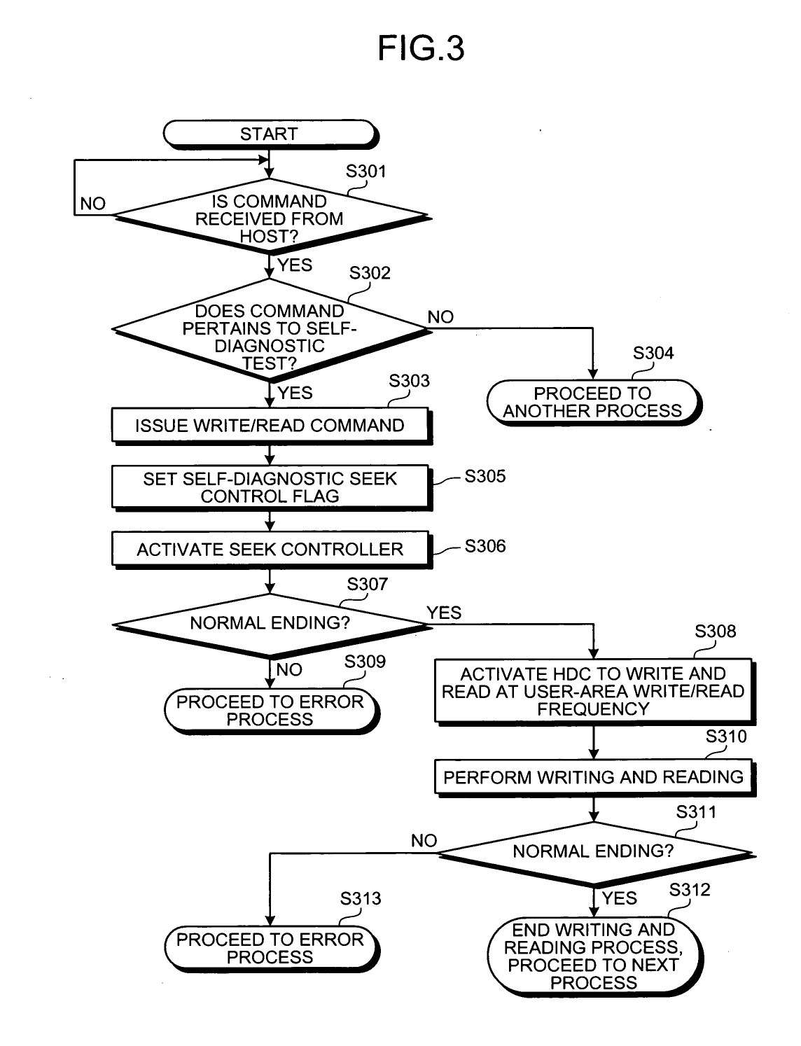

FIG. 3 is a flowchart of a process procedure performed by the magnetic disk device 10 when performing a self-diagnostic test.

Upon receiving a command from the host 20 (Yes at step S301), the command controller 2 checks the content of the command (step S302). If the content pertains to a self-diagnostic test (Yes at step S302), the command controller 2 issues a Perform self-diagnostic test command to the write/read activating unit 3. Upon receiving the Perform self-diagnostic test command, the write/read activating unit 3 issues to the formatter control unit 4 a Write/Read command (specifying therein a predetermined sector of the user-area for writing data to and reading data from) to write data to and read the written data from the user-area of the disk 9 (reading followed by writing) (step S303).

If the content does not pertain to self-diagnostic test (No at step S302), the command controller 2 issues to the write/read activating unit 3 a command in response to the command issued by the host 20 (for example, normal write command or read command), and proceeds to carry out a different process (step S304).

Upon receiving the Write/Read command from the write/read activating unit 3, the formatter control unit 4 creates a self-diagnostic seek control flag indicating that the seek operation is for self-diagnosis, and sets the self-diagnostic seek control flag in the seek controller 5 (step S305), and activates the seek controller 5 (step S306).

Once the seek operation of the head ends normally (Yes step S307), the formatter control unit 4 activates the HDC 8 (step S308). If the seek operation does not end normally (No at step S307), the magnetic disk device 10 proceeds to carry out an error process (such as setting error status) (step S309).

The activated HDC 8 writes data to and reads data from the disk 9 (step S310). If the write and read processes by the HDC 8 ends normally (Yes at step S311), the magnetic disk device 10 ends the writing and reading processes of the self-diagnostic test, and proceeds to the next process (involving comparing the written data and the read data to check for data garbling) (step S312). If the write and read processes by the HDC 8 does not end normally (No at step S311), the magnetic disk device 10 proceeds to carry out an error process (such as retry of write and read processes by the HDC 8) (step S313).

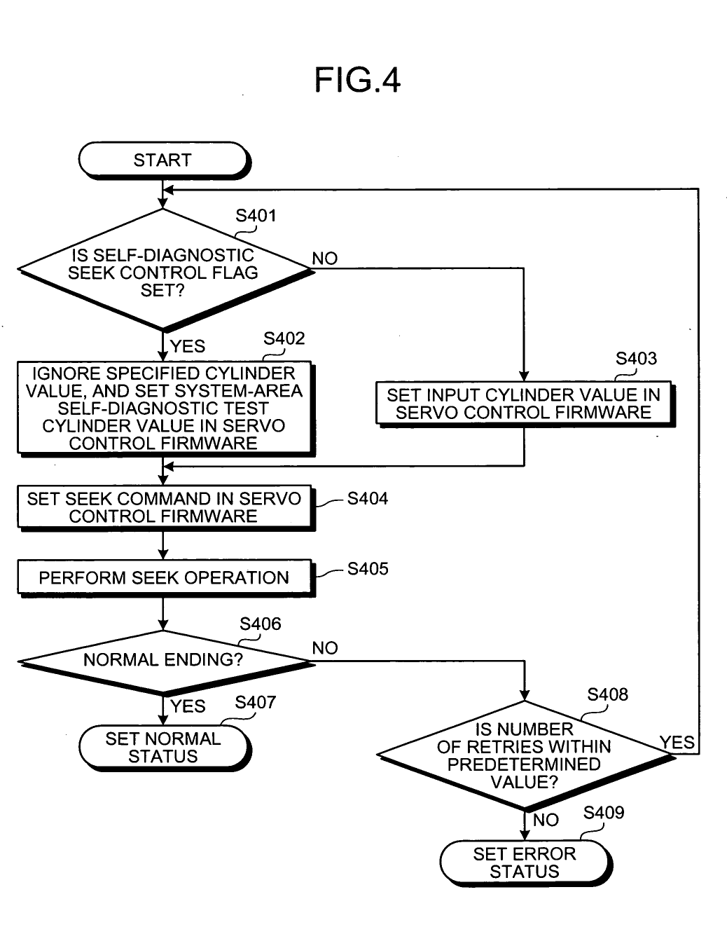

FIG. 4 is a flowchart of a seek control process performed by the magnetic disk device 10. The activated seek controller 5 checks whether a self-diagnostic seek control flag is set (step S401). If the self-diagnostic seek control flag is set (Yes at step S401), the seek controller 5 ignores the cylinder value specified in the command received by the formatter control unit 4 from the write/read activating unit 3, and sets a self-diagnostic test cylinder value such that the head is positioned at the diagnostic cylinder (step S402) along with a Seek command (step S404) in the servo control firmware 6.

If a self-diagnostic seek control flag is not set (or if a non-self-diagnostic normal seek operation is to be performed) (No at step S401), the seek controller 5 sets the cylinder value specified by the write/read activating unit 3 (step S403) along with a Seek command (step S404) in the servo control firmware 6.

The seek controller 5 then activates the DSP 7. The activated DSP 7 receives control directions for the head position from the servo control firmware 6 and, if the self-diagnostic seek control flag indicating that the seek operation is for self-diagnosis is set as at step S401, performs a seek process of the head in the diagnostic cylinder provided in the system-area of the disk 9 (step S405).

If the seek operation of the head performed by the DSP 7 ends normally (Yes at step S406), the seek controller 5 sets a normal status (step S407). If the seek operation of the head performed by the DSP 7 does not end normally (No at step S406), the seek controller 5 checks whether the number of retries for the seek operation is within a predetermined value (step S408). If the number of retries is within the predetermined value (Yes at step S408), the seek controller 5 proceeds to retry the seek operation. If the number of retries is not within the predetermined value (No at step S408), the seek controller 5 sets an error status (step S409).

Thus, according to the first embodiment, the magnetic disk device 10 uses the user-area write/read frequency as the writing/reading frequency to write data in and read data from the system-area when performing the self-diagnostic test. Consequently, a self-diagnostic test to detect a user-area write/read frequency-dependent head or circuit failure is performed in the system-area. Thereby, the risk of data loss from the user-area is eliminated.

The first embodiment is explained by taking an example where the magnetic disk device 10 receives a command from the host 20 and thereafter performs the self-diagnostic test. The magnetic disk device 10 can be configured to perform periodic self-diagnostic test automatically even if no command is received from the host 20.

The present invention is not restricted to the embodiment described above alone, but can have different forms. Other embodiments of the present invention are described below.

If the user-area of the magnetic disk device according to the first embodiment consists of a plurality of sectors of different user-area write/read frequencies, writing and reading during self-diagnostic test can be performed for each sector using the user-area write/read frequency of the concerned sector.

Thus, head or circuit-failure dependent on the different user-area write/read frequencies of the plurality of sectors of the user-area can be detected, enabling a more detailed self-diagnostic test.

In the first embodiment, writing and reading during self-diagnostic test can be performed using the highest user-area write/read frequency from among the different user-area write/read frequencies of the plurality of sectors of the user-area.

Thus, the self-diagnosis test can be performed under the severest condition to detect the user-area write/read frequency-dependent head or circuit failure. In addition, since self-diagnosis test is not performed sector-wise, the time taken for the self-diagnosis test is reduced, making it efficient.

The constituent elements of the magnetic disk device 10 shown in FIG. 1 are merely conceptual and may not necessarily physically resemble the structures shown in the drawings. For instance, the magnetic disk device 10 need not necessarily have the structure that is illustrated. The magnetic disk device 10 as a whole or in parts can be broken down or integrated either functionally or physically in accordance with the load or how the device is to be used. For example, the write/read activating unit 3 and the formatter control unit 4 can be integrated. A device provided with all the process functions performed by the magnetic disk device 10 can be applied as a part of the magnetic disk device 10 so that the processes (see FIG. 3 and FIG. 4) described with regard to the first embodiment can be realized. The process functions performed by the apparatus can be entirely or partially realized by a central processing unit (CPU) or a program executed by the CPU or by a hardware using wired logic. Apart from a magnetic disk device, the present invention can be applied to an optical disk device such as a digital versatile disk (DVD), or magneto-optical (MO) disk.

The process procedures, the control procedures, specific names, etc., can be changed as required unless otherwise specified.

According to an embodiment of the present invention, when performing a self-diagnostic test (such as, upon receiving a command for a self-diagnostic test from a higher-level device or when periodic self-diagnosis is performed automatically), the user-area write/read frequency is used as a writing/reading frequency for a self-diagnostic writing/reading, and the system-area is used the area in the recording medium for performing the self-diagnostic writing/reading. Consequently, a self-diagnostic test to detect a user-area write/read frequency-dependent head or circuit failure is performed in the system-area. Thereby, the risk of data loss from the user-area is eliminated.

According to the embodiment, if the user-area has a plurality of sectors of different user-area write/read frequencies, the self-diagnostic writing/reading is performed sector-wise using the user-area write/read frequency of the concerned sector. Thus, head or circuit-failure dependent on the different user-area write/read frequencies of the plurality of sectors of the user-area can be detected, enabling a more detailed self-diagnostic test.

According to the embodiment, the self-diagnostic writing/reading is performed using the highest user-area write/read frequency from among the different user-area write/read frequencies of the plurality of sectors. Thus, the self-diagnosis test can be performed under the severest condition to detect the user-area write/read frequency-dependent head or circuit failure. In addition, since self-diagnosis test is not performed sector-wise, the time taken for the self-diagnosis test is reduced, making it efficient.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A storage device including a recording medium having a user-area and a system-area, and that implements a self-diagnostic test, the storage device comprising:
a writing/reading unit that, in the self-diagnostic test, performs writing of data in and reading of data from the system area at a user-area write/read frequency that is a frequency for writing of data in and reading of data from the user area.

2. The storage device according to claim 1, wherein the user-area includes a plurality of sectors each corresponding to a different user-area write/read frequency, and
the writing/reading unit, in the self-diagnostic test, performs writing of data in and reading of data from the system area at each of the different user-area write/read frequencies.

3. The storage device according to claim 2, wherein the writing/reading unit, in the self-diagnostic test, performs writing of data in and reading of data from the system area at a frequency that is highest from among the different user-area write/read frequencies.

4. A control device that causes a storage device to perform a self-diagnostic test on a recording medium having a user-area and a system-area, the self-diagnostic control device comprising:
a writing/reading unit that, when causing the storage device to perform the self-diagnostic test, performs writing of data in and reading of data from the system area at a user-area write/read frequency that is a frequency for writing of data in and reading of data from the user area.

5. The control device according to claim 4, wherein the user-area includes a plurality of sectors each corresponding to a different user-area write/read frequency, and
the writing/reading unit, in the self-diagnostic test, performs writing of data in and reading of data from the system area at each of the different user-area write/read frequencies.

6. The control device according to claim 5, wherein the writing/reading unit, in the self-diagnostic test, performs writing of data in and reading of data from the system area at a frequency that is highest from among the different user-area write/read frequencies.

7. A method of performing a self-diagnostic test on a recording medium having a user-area and a system-area, the method comprising:
performing, in the self-diagnostic test, writing of data in and reading of data from the system area at a user-area write/read frequency that is a frequency for writing of data in and reading of data from the user area.

8. The method according to claim 7, wherein the user-area includes a plurality of sectors each corresponding to a different user-area write/read frequency, and
the performing includes, in the self-diagnostic test, writing data in and reading data from the system area at each of the different user-area write/read frequencies.

9. The method according to claim 8, wherein the performing includes, in the self-diagnostic test, writing data in and reading data from the system area at a frequency that is highest from among the different user-area write/read frequencies.
